(19) United States
(12) Patent Application Publication
(10) Pub. No.: US 2012/0203607 A1
(43) Pub. Date: Aug. 9, 2012

(54) Commercial Credit Circuit

(76) Inventor: Hendrik Geert Pieter Van Arkel, Utrecht (NL)

(21) Appl. No.: 13/501,316

(22) PCT Filed: Jan. 12, 2011
(86) PCT No.: PCT/IB2011/000179

§ 371 Date: Apr. 11, 2012

Related U.S. Application Data
(63) Continuation of application No. 12/657,040, filed on Jan. 13, 2010.
(60) Provisional application No. 61/296,507, filed on Jan. 20, 2010.
(60) Provisional application No. 61/358,571, filed on Jun. 25, 2010.

(51) Int. Cl. G06Q 40/06; G06Q 30/02

(52) U.S. Cl. 705/14.17; 705/36 R

(57) ABSTRACT

A system is compatible with money and is usable to settle debts and/or for providing liquidity in a marketplace. The system uses standardized claims on future payment in an administrative process to provide a source for settlement of obligations between parties and to extend the period in which cash is not needed as a tool for commerce. This means of exchange can be established and used to introduce tools to have the circulation of local purchasing power inside the management system or region optimized. Using computer and specific formulas and approach allows tagging monetary flows in order to optimize the use of its potentials.

### RELATED APPLICATIONS

This application is being filed on 12 Jan. 2011, as a PCT International Patent application in the name of Hendrik Geert Pieter van Arkel, a citizen of the Netherlands, applicant for the designation of all countries, and claims priority to U.S. Patent Application Ser. No. 61/296,507 filed on 20 Jan. 2010, U.S. Patent Application Ser. No. 61/358,571 filed on 25 Jun. 2010, and U.S. patent application Ser. No. 12/657,040 filed on 13 Jan. 2010. The entireties of these applications are hereby incorporated by reference.

### BACKGROUND

These days we see in the Philippines and parts of Africa the realization of complex payments through a system based on the value of prepaid airtime minutes. While the calculation in values is still being done in terms of money, the actual transaction is done in claims on services or goods.

The world economy revolves around money changing hands for services and goods provided with the payment system for these exchanges dependent on the availability of money to facilitate exchange. However this means of exchange is scarce and typically interest is charged for the use of it and therefore not available to everybody that has business opportunities. In some cases, mutually dependent producers in an economic transaction solve this problem by settling their accounts with a net difference payable by the producer in deficit position. These modes of transaction almost always utilize an economic structure of one party owing or another party paying for goods and services. Sometimes a system incorporates a community of interested parties in a transaction that does not directly involve a debtor paying back to the creditor; however purchasing power in these systems are explicitly not cashable in money and cannot leave the specific barter-network in which they are created.

Money-related exchange in a community requires capital capacity by the debtor or potential debtor to match or be leveraged in a transaction with a creditor or potential creditor. Both the lack of facilitation to exchange among each other as well as the interest costs for an organization, add to poverty especially in the low-income communities who are net-interest payers. Also and less known is that these interest costs of money that are attributable to time have severe environmental impact since it forces users of the global monetary system to earn additional money as soon as possible to pay usually external interest earning operators, whilst also forcing economic choices to a shorter time scale which often have an ecological damaging impact.

On micro level, in a typical purchase transaction, a small enterprise would be required to pay for its purchases or orders within 30 or fewer days, while the larger entities extend these due dates up to 90 days from date of invoice. A small enterprise that serves or supplies to a large one is typically at a disadvantage of being required to pay within 30 days but waiting to be paid within 90 days. If such smaller entities are without adequate cash flow, the cost of doing business becomes high.

### SUMMARY

This disclosure preferably includes a method of organizing commerce through administrative records based on future claims on money. This disclosure is directed to a novel private payment system, referred to as the Commercial Credit Circuit or C3, that is substantially compatible with money, allowing it to have the option to swap under certain conditions money to purchasing power in that payment system and vice versa, while being competitive with monetary transactions in favor of the users. The examples described herein provide opportunities to trading parties or communities, in a process that provides capacity to efficiently engage in commerce. This disclosure also facilitates commerce with non-reliance on the price of money (interest) but instead with the risks involved in securing the claims according to monetary value.

Another aim of this disclosure is to obviate the need for cash in communities or expensive credit in order to allow economic actors to optimally engage more with each other in the current global monetary system.

Another aim of this disclosure is to motivate owners of money to spend their purchasing power locally at the group of participants of the C3 private payment system. The examples described herein therefore includes the introduction of a system or means to motivate or entice participating individuals or entities to exchange money for value claims without jeopardizing the system and to allow the exchange vice versa.

The present disclosure further includes a method of managing the money-replacing value claims system in such a way that the age and the quantity of times the claims are used as units of exchange in a defined environment can be monitored. Based on this method, the examples can be applied to introduce tools to swap costs from those that need a credit to those that profit off the purchasing power initiated by that credit and to encourage the money replacing value claims to circulate a specific quantity of times in a defined area. This allows a policy that stimulates economic activities in a specific area and can be used to optimize the output of that area, local or national economy. This method can be used to increase the multiplier of the purchasing power and through that the economic impact of monetary flows that enter specific target areas.

In example embodiments, the systems and methods described herein are directed to one or more of the following:
create enhanced conditions for innovation in this field in favor of consumers, small and medium companies and regions where economies are underperforming;
be able to enforce transparency and accountability by the organizers towards the users of these methods and technologies;
to avoid the misuse of these technologies and methods; and
to collect the funds to support further research and design in this field and to reinforce the use worldwide.

### DESCRIPTION OF THE FIGURES

FIG. 1 shows a supplier delivering a product to a contractor in exchange for value claims.

FIG. 2 shows the supplier exchanging the value claims for cash.

FIG. 3 shows the supplier spending the value claims at its own supplier.

FIG. 4 shows that supplier of the supplier holding value claims that can be exchanged for cash with only minor transaction costs.

FIG. 5 shows the system repaying a loan to a bank.

FIG. 6 shows a client buying a product.

FIG. 7 shows a shopkeeper obtaining money in advance.

FIG. 8 shows the exchange of the right for cash payment.

FIG. 9 shows the customer making a purchase.

FIG. 10 shows the generation of liquidity for a debit-account.

### DETAILED DESCRIPTION

One purpose of this disclosure is to provide a new private payment system that can be made wholly compatible with money. The present system preferably uses money as a measure of value while substantially bypassing the costs of the use of money. This disclosure also preferably includes a method of organizing commerce through an administrative system based on future claims on money. It is one objective to preferably replace money with a system in which payments are settled with transfer of standardized value claims.

Through eliminating the need of interest payments it restores the importance in the commercial decision making of economic depreciation above financial calculations which results in longer term investments and contributes to the environmental needs.

In an embodiment, a transaction claim is preferably established when a claim belonging to an individual or entity is secured by bank or other credible or reliable guarantees or guarantee-issuers.

In examples described herein, the claims are facilitated by a claim management system called ‘Commercial Credit Circuit’ (‘C3’).

In the C3, a claim on future payment is swapped into a standard transaction claim that provides a way to settle debts and act as a resource for trading parties or communities in a transparent, standardized and secure way. The use of such claims preferably provides a system wherein such value claims can be made on a non-interested party after the initial transactions have occurred. A non-interested party is a party that is not directly involved in the initial transaction between the issuer of the claim and the participant in the system that receives the claim because of being the supplier of the party that was involved in the initial transaction. Claims that circulate as purchasing power inside the trading community using the C3system are towards specific legal entities and are secured by a recognized financial institution or by at least a reputable insurance company.

As an example, a participant in the system of the present disclosure provides a secured instrument, a claim, wherein such a claim or instrument may be based on a future payment promise for the supply of money or the provision of goods or services to a beneficiary and in which this future payment promise is secured by a reliable third party.

One example where the present disclosure can be applied is the following: a purchaser who receives services or goods from a supplier has an obligation to pay a value in money for these within a specified period of time. Such obligation creates an indebtedness that may be satisfied by cash payment or as typically the case in business, can be compensated by a future claim in favor of the supplier. It is reasonable to expect businesses to delay the payment for these types of services between 30 and 90 days, if not longer. It is further reasonable to assume that the supplier of such goods or services may need to be paid sooner than later. In most instances, such supplier would likely need financing to meet his or her actual need of cash, soon after the delivery of the goods or services in order to continue to produce for future customers. This cost of financing such as interest or other costs, may prevent some entities from continuing in business at worst, or cause costs and hardships for the supplier, in the least.

This disclosure provides a means to bridge the gap described above between the moment of delivery of goods or services and the moment the money actually becomes available for the payments. After delivery, the purchaser can secure the resulting invoice and swap that secured claim into standard claims in the C3. Next these standard claims can be used as means of payment to purchase and pay products to any provider that is member of the network and that is willing to accept that as payment.

The requirements of the insurance of the payment, or payment guarantee according the present disclosure should be based on requirements or standards determined by a third party financial or insurance facility that is fully responsible to provide the cash if the claim on the purchaser can not be cashed at the date requires for fulfillment of the payment obligation. This insurance or guarantee is guaranteeing the payment of a specific future payment promise that may have a due or maturity date. The user of the present system that wants to obtain internal purchasing power presents the invoice and the guarantee to the administrative system in exchange for standardized value claims.

The obligation to pay at maturity day is first of all an obligation of the individual or company that exchanged the payment promise (that can but not necessarily consists of an invoice towards a third party) for a standard claim. However if this promised payment is not paid it is an obligation of the guarantee facility to pay the value in money in exchange for the claim. The owner of a standardized value claim of the present disclosure may present the claim to any supplier that, upon registration with the administrative system of the present disclosure, will get this value on his/her account. The standardized value claims on that account can be cashed as soon as the payment promise on which the claim is based has met its date of when cashing is allowable, and/or the technology and method that calculates the age declares that the date has come or passed, but also still be used to conduct commerce within the administrative system of the present disclosure. It is reasonable for the supplier of the first instance to utilize his or her standardized value claim for the purchase of goods and services from yet another supplier who, by virtue of being part of the system, may convert this claim to cash when allowable, if needed. Suppliers and purchasers can maintain the use of these claims in their marketplace without the generation of cash. As these claims circulate within the system, the need to borrow cash or approach financial institutions for bridge funding may be minimized or eliminated, thus providing a system that is substantially compatible with money yet eliminating the direct cost of capital for the parties.

The example system also may introduce some principles and rules to encourage or regulate the circulation of these value claims as well as the motivation for the use of these claims and/or to avoid the accumulation of claims within an entity—such would be detrimental to the system but may benefit a member or registrant with resources at the expense of the whole system. To address this potential imbalance, the present disclosure may include a means to encourage commerce by the application of revenue generators or costs to those who may desire to slow down the circulation of standardized value claims.

Such principles, according to the present disclosure, may include costs for those users of the system that prefer cash to claims. Such principles may include that when the claims are not yet cashable, the cashing of the claims will generate income for the system, that will cover administrative and regulation costs as well as the costs of attracting the cash for the time until the claims are being eliminated by a payment of cash from the company or individual that requested the system to create the claim in the first place. It is preferable that these sources of income for the system, which are costs for the users, are transparent and previously known to users of the system.

These sources of income are typically not lower than the costs of pre-financing the cash in the case users want to cash the claims before the agreed date of payment of the claim by the member that was allowed to introduce that claim in the system or its guaranteer. The costs charged on these users can also be used as an instrument to keep the purchasing power circulating longer in the system. These costs might vary depending on the age or the quantity of use based on capacity of the present disclosure that allows calculating the duration of use of value claims within the system as well as the quantity of times the claims have been used to facilitate transactions. The calculation of duration of times of use can be used to evaluate charges and make these gradually diminish (diminishing malus) but also to provide options for policies to create cheaper trade capital or to stimulate a more intensive circulation of the purchasing power in a particular area.

The administrative system of the present disclosure also is adaptable for use by financial institutions such as banks, insurance companies, brokerage houses, and the like. The system of the present disclosure may present a collection, or all of the original values the standardized claims are based on, for deposit in a participating or contracted financial institution. Upon redemption of these original claims, that institution may provide new immediate cashable claims to the system or cash for those who have needs that cannot be met by exchange of claims.

One advantage of this system is the extension of time before cash is needed within the system. The administrative system also might contract a financial institution to provide the means to deliver sufficient arrangements to provide cash to be available to those who need cash before the date the claims will become cashable. If the system does not have such a contracted partner, cash might only be available when cash comes in. This can be distributed towards the holders of standardized claims in many ways apart and combined, such as, in a time sequence, based on age or use of their claims and through an auction in which the ones that make the highest bid over the nominated value gets priority to take it, while the system may choose to use this additional income to borrow cash and extend the auction.

Another advantage of the present disclosure is the encouragement of commerce and employment by the extension of liquidity and possibly even credit in the market place. As a supplier does not have to be enamored with the need for immediate cash flow, such supplier or employer may keep his or her sights focused on production of goods and services, thus an avenue to grow the business and maintain employment in the small businesses which are known to be the largest employer of labor. Thus, this disclosure provides resources to reduce unemployment.

In another embodiment, the administrative system may be utilized by workers in the transfer of resources to their home families wherever they may be. Such a remittance may be made within the system for a family member who receives value claims that are acceptable within the system that administrates accounts of retailers and producers that live near the family. Each remitter may be rewarded with a bonus for using the system as an encouragement. The recipient utilizes the funds remitted as a value claim within the system to buy at a local retailer or might request cash, which will be available against certain costs. These costs that may be charged for any cash or non-system use may be at least as high as the bonus plus a value targeted to encourage purchasing within the system and community.

The present system may also offer the remitter the opportunity to share an account in the system with his/her family in a way that allows him/her the opportunity to check and/or approve expenditures by his/her family.

The present disclosure includes a technical solution and a method of managing the standard transactional value claims system in such a way that it can measure the age of the claims, the number of days that the claims are away from being nullified by the promised cash payment, as well as the quantity of times these values have been used for transactions in the system, or the number of times the circulating values still have to circulate before a predefined quantity of times has passed. Based on this information, and within the rules implemented in the system, the dynamics and the costs in the system can be influenced by imposing specific fees, most especially in the case of the exchange of standard value claims for money. This allows, for example, a system to accept purchasing power in the circuit introduced by a government and establish rules to stimulate that that will persuade purchasing power to circulate a defined quantity of times in the area where the circuit or a sub-circuit is determined, facilitating a targeted number of economic activities that might result in additional employment and tax income. The costs of cashing the claims, to potentially use the purchasing power elsewhere, can be set very high for purchasing power that just entered the system and low for purchasing power that has been used in the system often, in other words that has stimulated economic activities in the area where the system functions. This disclosure allows the stimulation of the economy of groups of participants living in a specific area. Based on this extended use in that area it is recognizable that the intermediation of this disclosure can extend the tax income resulting from governmental expenses considerably.

Also it is recognizable that the intermediation of this disclosure does not exclude world trade in anyway and will finally result in precisely the same quantity of purchasing power in cash available for purchased outside the targeted area as that has entered the system in the first place.

The present disclosure preferably includes a method of reinsuring the value of the circulating claims in order to allow users of the system to accurately determine the monetary value of the standard claims they own in the system. In this system, standard claims in the system are preferably backed by a guarantee from a suitable financial institution to pay the underlying value under any circumstances on a particular date.

This disclosure also preferably includes a method of organizing commerce through administrative records based on future claims on money. It is one objective of this disclosure to preferably substantially replace the use of money in trade by a system with standard value claims, utilizing such claims to provide resources to trading parties or communities, and preferably providing a system wherein such standard value claims can be created on a low cost base bypassing the required cost of interest if the trade would be facilitated using money.

In order to provide a trustable system, the claims which the internal units of account are representing need to be secured. Since the costs of bank guarantees or insurance of claims, such as bills, are less than the interest banks demand for cash and moreover also insure against non-payment, the system offers an excellent alternative to diminish the costs of trading processes and the short term credits. Through this system claims on future cash become an effective means of trade, liberating entrepreneurs and communities of the need to pay interest to administrate mutual transactions.

In this example, a system for managing exchange of standardized value claims usable for the transaction inside the network preferably includes at least the following paths or options to create a value claim. These paths may be created independently or in combination with other suitable paths. Some of the paths include:
deposition of funds by users potentially attracted by bonus to buy standard value claims;
deposition of payment promises at a specific moment in time, secured by banks or big insurance companies; and
any other claim on future cash that has been properly secured.

In the present disclosure, the ownership of the individual claims that are at the base of the claims circulating within the claim management system can reside with the financial institution that guarantees payment to the claim management system. In that case, holders of claims within the claim management structure that would like to transfer their claims for cash, have to negotiate the option of selling their standard claims for money with that financial institution. The information provided by the claim management system will be input for that institution to use for cost calculation.

In another embodiment, private value claims are owned by the entity that runs the claim management system. Also the claim on the payments by the financial institution that guarantees the payment of the claim, in case that claim proves not to provide the cash on expiring date, is owned by the claim management system. In that case the holders of standard value claims within the claim management system can request conversion of the entity that runs the claim management system. The entity in the present disclosure may allow that conversion/cashing according to the established process and procedures. Where there are costs or charges, such costs or charges are at least the costs a contracted financial institution may claim to pre-finance the cash at the moment the cash is requested. This provides the option that when the entity itself expects not to have enough cash available for exchanging claims for money at any given moment, the entity still can promise to the users of the system cash payment at any time in exchange for standard value claims and under clear conditions.

In another embodiment, private value claims are owned by the people that can be identified through the claim management system. These members also own the claim on the payments by the financial institution that guarantees the payment of the claim, in case that claim proves not to provide the cash on expiring date. In that case the holders of standard value claims within the claim management system that are in need for cash before the expiring date of their claim can sell their claim against cash if there is a market for it. The claim management system can organize an auction where potential sellers and buyers can engage and any financial organization might broker deals. In this embodiment it might be that the claims are individual recognizable or these can be consist of ownership shared with others.

Unlike a so called Barter system, the claim management system of the present disclosure is purposefully based on future payments of money supported by guarantees denominated in currency or in specific instances by the availability of currency itself. The system also provides a means to increase revenue by charging a fee or tax when a user redeems his or her value claim. This process allows for a conversion-fee (in C3 often called Malus) to be charged when the transaction occurs or accrued on the respective ledgers. This charge has the benefit that it can be intentionally used to rearrange preferences towards not cashing but using the claims to exchange goods or services produced inside the system, which would reinforce the economic activities in that particular group of participants.

In the more advanced systems in which the ‘age’ or ‘use’ of the value claims in circulation is being measured, the costs of exchanging the claims for money might depend on either the average time still to go before the claims will be paid or the quantity of times the value claims have been used to facilitate trade inside the system.

Another aspect of the process of the claim management system is a means wherein transaction with the value claims can be stimulated. The system knows the option to introduce an interim bonus that awards either the buyer or the supplier in a specific position in the productive chain with a percentage additional value claims. When a participant in the present system executes a transaction, whether that transaction is adding to the balance sheet or subtracting, an incentive may be provided to encourage such for the collective benefit of the system.

The administrative or management system of the present disclosure may also provide a process for ranking transactions within the system. Such rankings may be used to determine or assign categories or order to the users of the system. As an example, there may be a process to rank order depositors who have either by time or quantity of transactions impacted positively or negatively, the strength of the system. Other exemplary opportunities include ranking the value claims in terms of time related to the time that the claim may be paid by the administrative system and for the period of time that has elapsed. The ranking can be used to allow specific rules, also for conversion of value claims in the system to cash.

In one embodiment that provides liquidity in the market place, a user of the claim management system may be a purchaser who is supplied with goods or services by a supplier. The purchaser may be an individual, business entity, non-profit corporation, municipality, local government or any other structured facility with the capacity to make a payment promise backed by a guarantee of an appropriate institution. Such purchaser may claim domicile in any location and is not limited to form or substance.

In the case the purchaser bought the claims from the administrative system with cash, this money is available for those that want to convert their claims to money, and maybe an specific and transparent part for paying the costs of the system. The actual process of conversion can be executed by the administration of the system or be transferred to a financial institution through a contract.

Such a financial institution includes, but is not limited to, a bank, insurance company, investment house, broker or any other facility with the capacity to maintain and retire such deposits with minimal risk to the management system or the users of the system.

A ranking system may be created by the administrative system for the management of the funds and conditioning of transactions and rules. Such ranking system may influence means for upgrading, degrading, encouraging or discouraging operations in the management system. A ranking system for transfers in the administrative system may include fines M (for Malus/conversion fee). A Malus is a conversion fee or tax or fine that may be levied for conversions of claims within the system that is denoted to attract a fee, tax or fine.

Also, the ranking system can be related to taxes T (for Transaction Tax) which become the revenue source for the system as well as an instrument to guide the purchasing power towards or inside the system. C-ranking, D-ranking and A-ranking relate to the history of a claim. After a transaction has been done, this transaction can impact the C-ranking of this claim. The time that passes impacts the A-ranking, while D-ranking changes each time the claim progresses towards its payment date.

An exemplary mathematical model for generation of ranking and revenue is included in Equations I-XXXVI of Appendix A, which are hereby incorporated by reference.

The present disclosure includes exemplary mathematical models for incorporating relationships between balances, transactions, ranking and age of the funds used in of the present disclosure. The relationships between balances, transaction, ranking and time that can be used to offer incentives or apply costs that allow a smooth functioning or specific targets.

As explained before, in an embodiment of the present disclosure, value claims are introduced in the marketplace that can be used as liquidity within the management system. Upon the need to settle debts and make commercial transactions, the holder of a value claim may exchange for value with another user in the system as determined by the claims management system.

The risks that comes from a situation in which some or all claims cannot be cashed by the management system or by the users of the system may preferably be backed by guarantees from a recognized financial institution or by at least a reputable insurance company. The management system of the present disclosure thus preferably provides a method of providing claims on cash available for commerce which can be used to facilitate exchange in locations of low economic capacity without the challenges of the current economic disposition that favors disbursement of funds in locations of high economic capacity. The present disclosure also provides a means to increase the availability of economic capacity as a stimulus for stagnant economic conditions without the introduction of additional money as a primary input.

Additional details of the management system described herein can be found in U.S. Patent Application Ser. No. 61/296,507 filed on Jan. 20, 2010, the entirety of which is hereby incorporated by reference.

In another embodiment, the claim management system is used as a clearinghouse of a mutual settlement of debits and credits between trading partners, in which the claims on the values that are being transferred have a defined (future) relation with a given currency.

The C3 management system introduces a regional or national accepted form of exchange to stimulate the circulation of purchasing power. The management system provides a clearinghouse of a mutual settlement of debits and credits between trading partners, in which the value of the amounts that are settled has been tied to the national currency. The C3 stimulates regional trade, both by creating more liquidity for the participating businesses, as well as by applying tools that keep that liquidity circulating locally as long as optimal.

The C3 model offers new forms of credit, which are not based on lending money, but on supplying a local means of exchange that is not charged with interest.

As explained in more detail, when in need for liquidity, a company can get a line of commercial credit to spend within the C3 network, if that claim on that company can be sufficiently guaranteed. This credit is the creation of claims on repayment of money that can be used as any other claim to obtain products from all other participating companies that will accept payments in claims. So, if acceptable for the C3, when a company makes a promise to pay a certain date in the future 1000 in the national currency, and this payment-obligation is secured by a capable institution, that company will get a value of 1.000 in claims, on the online account in value claims it has in the system, which it can spend with supplying companies in exchange for goods if these accept payment in these value claims. The difference is that no real money circulates within the network.

When the credit is due, the debtor of the credit has to repay in money. In case of default, the C3 actions the guaranteeing institution. The money that the C3 receives is passed to the suppliers of goods and services that have a positive balance of Value Claims and are in need for money.

Value Claims can thus be either spent within the C3 network, or exchanged for money. Of course, the money will come only after the credits have been paid. Therefore, if suppliers want to cash their Value Claims earlier, they will have to pay the interest costs of advancing this money, if a financial institution or a market party is willing and capable to do so.

In the example shown, software tracks the flow of Value Claims and informs the system and its users of the amount of time the holders of positive balances will have to finance if they want to cash their Value Claims at a certain moment. Holders of Value Claims can thus either choose to spend their Value Claims at face value within the C3 network, cash them now and pay the costs, or wait till the credits/claims that back the Value Claims are compensated in cash and the money is thus available without additional costs of interest.

In one example, this software is implemented on one or more computing devices. Each computing device can include hardware and software. The hardware can include a processor, system memory, and input/output devices. The system memory can include one or more physical media (sometimes referred to as ‘computer-readable storage media’) that store instructions that are implemented by the processor. The input/output devices can include keyboard, mice, mobile phones, card readers, printers, etc. Other configurations are possible.

One goal of the C3 network is to supply credit-worthy businesses with short term means of payment that serves as transaction capital and that does not depend on a monetary bank-loan and is thus cheaper and more readily available.

On a macro level, the C3 extends to create more liquidity in the local market and thus stimulate local trade, when monetary flows might have ‘allocated’ the money towards more dynamic markets or regions.

The C3 mechanism involves the following steps:
C3 offers a network in which participating businesses buy and sell goods and services between each other. This network includes a system of online accounts, on which the businesses hold their balances in Value Claims. Users can connect the accounts via Internet, mobile phones, card readers, etc.
The Value Claims (just as any other means of payment) can be earned by selling goods or services to other participating businesses, or can be applied by the network as credit, thereby generating the possibility to buy products now, and pay the money later.
The business that holds Value Claims has a claim in future money payment on the ones that initiated the claims in C3 network and if these do not pay on the institution that guaranteed these claims. When the one that owns Value Claims does not want to spend these within the network, it can ask to convert its Claims in cash.
All the Value Claims are backed either in existing cash or in guaranteed promises in cash. The guarantees must be offered by capable third parties, such as guarantee funds, financial institutions or credit insurance companies.
The C3 thus allows businesses to create Value Claims that they will pay in cash at a specific later date. This commitment to pay money at a later date is guaranteed by third parties.
The costs that a company will have when opting to cash the Value Claims, are at least determined by the amount of time before receiving the money the Value Claims promised to pay at a specific date.
Because the need for businesses to exchange Value Claims for money might be bigger than the actual cash in the C3 bank account based on the (re)payments of Value Claims that are due, the C3 can hold credit-lines at banks to be able to cash Value Claims into Euros at any moment, or outsource this process.
The business that has obtained Value Claims (hereafter referred to as business A) opens a checking account in the C3 clearing-network and electronically spends the Value Claims by, for example, paying its supplier (business B). Business A will have a commitment to pay for these Value Claims in money, in a predefined period, e.g. 90 days.
To receive its payment, business B only needs to have its own checking account in the network. Business B has now two options: either cashing the Value Claims for national currency (at the cost of at least paying the interest for the outstanding period, e.g. 90 days, plus fees); or to pay its own suppliers with the Value Claims, within the C3 network, thereby using these Value Claims as a liquid means of payment at face value.
When business B wants to cash its Value Claims before these have been paid for in money by business A (in this example, before the 90 days are due) the C3 might borrow this money from the contracted bank, and will charge B at least for the interest for the period that the C3 has to wait until the claim come due. This process might be outsourced or might be organized as a market activity using any market mechanism.
Instead of cashing the Value Claims and paying interest, business B can opt to use the positive balance on its account within the network, for instance to pay its supplier, business C.
Business C also needs to have an account in the network. It has then the same two options as business B: go for cashing the Value Claims for national money, or spend within the network. And so on . . . .
In this process, time goes by, and the outstanding period before the money of business A is expected becomes shorter. Therefore, business X, Y or Z will have to pay less interest costs if it wants to cash the Value Claims, and, at some point in time when the time span of the credit to business A has passed and the claim gets paid the amount of the credit in cash currency, either by business A or, in case of default of business A, by the guarantee fund or insurance company. This money is now available as cash for those that hold Value Claims of whoever owns at that point the proceeds of the credit to business.

Various benefits are realized through the use of the C3. For example, businesses increase their access to the short-term credit which they need in order to improve their working capital to make optimal use of their productive capacity. The size of this credit can be built up to a stable level at a cost substantially lower than when charging financial interest rates. In addition, the C3 opens a way that allows buyers to pay immediately (within the circuit), regardless of the payment schedule in money, injecting substantial liquidity at very low cost in the entire network. So, while the buyer has postponed payment facilities, the seller meets immediate payment, as long as he can also spend within the network. Only invoices and other claims that are 100% guaranteed, and 100% computerized, are acceptable in a C3 system. C3 thereby encourages the generalization and more efficient use of IT infrastructure among SMEs, including the opening of new markets and marketing channels through e-commerce.

The market also benefits. For example, more liquidity generates more circulation of goods and services and more tax-income. In addition, there is an increase in local customers, and the strategy can overcome the ‘vicious cycle’ of crisis and depression in a specific region. Also the C3 forces the market in general towards lower interest rates for short time credit.

For governments, the innovations associated with the C3 offer the opportunity to fine-tune the effects of a single currency used in an area with huge differences in the structures of the regional economies. It offers an innovative way to systemically reduce unemployment in specific regions. Governments at different levels (Federal States, EU, states, regional authorities) can contribute to a joint guarantee mechanism. Such a guarantee mechanism is considerably cheaper to fund than subsidies or other traditional approaches to reduce unemployment. Up to that, subsidies often create distortion of market mechanisms, while the guarantees only counter unfavorable conditions.

The C3 systems are best organized at a regional level, so that each network remains at a manageable scale. C3 allows management to introduce incentives that makes it for businesses better to spend their balances in the same regional network, and thus further stimulate the regional economy up till the point that the economy of that regions grows to full employment. C3 provides a win-win environment for all participants, and therefore promotes other collaborative activities among regional businesses. The C3 offers thus tools that can contribute to the stimulation of the local/regional economy, while maintaining the positive effects of the currency bond with other regions. The raise in economic activities as a result of C3 contributes to the tax revenues.

The Cyclos.4 software has specific elements that offer opportunities for highly innovative economic stimulation measures.

For example, Value Claims are emitted at different moments in time and circulate between the participants of the network. At any moment, the positive balance that a user has in Value Claims, is composed out of different flows of Value Claims between clients and suppliers that eventually end up at some participant's account. Therefore, any positive balance has Value Claims of different ages.

The methods and the concepts described herein allow software to keep score of the average age of each balance. This is called the D-ranking, or Date-ranking, which creates an indication for the C3 how much time it will take until as an average the Value Claim units on a specific account will need before they are being honored in money. The D-ranking enables to calculate how much lower the fee for conversion to money can be because the date comes closer to the date the claim is due. This information can be used to stimulate that a Value Claims circulates for a certain period of time before being exchanged for money as well as to allow to calculate the (interest) costs for those that hold claims and would like to have money instead.

Because of the D-ranking, even while Value Claims are being mixed and merged the C3 still can offer a transparent and standardized approach to calculate the costs of conversion to cash taking into account the expected sources of incomes (e.g. repayment of a loan, an unpaid bill) which helps to make the Value Claims can act as liquidity in the markets. These costs are being referred to as the Diminishing Malus; “Malus” expressing it is as kind of fine or exchange fee from the point of view of the person that wants to convert the units of Value Claims; and “Diminishing” because the amount to pay gets less and less. The main use of this D-ranking tool is to allow cheap commercial credit and to be able to swap guarantees that will deliver cash on short notice into liquidity avoiding the costs of money creation.

In addition, comparable with the above, the C3 keeps track not only of the time-span that Value Claims have been in circulation, but also of the amount of times they are used as means of payment. This is called the C-ranking, or Circulation-ranking, which indicates how many times each Value Claim has been transferred to facilitate transactions. The formulas to calculate the C-ranking for each holder of Value Claims are described herein. See Appendix A, which is hereby incorporated by reference. The C-ranking enables to charge a lower fee for conversion to money every time a Value Claim has been transferred to facilitate a transaction. In this way, the C3 can stimulate that it is likely that purchasing power associated with the C3 circulates a minimum number of times within the local market before the Value Claims are exchanged for money.

To avoid fake transactions the C-ranking can go hand in hand with a commission/transaction fee for every transaction. The C-ranking tool offers a government a guarantee that if the government spends money on stimulation programs through the C3, that money will stimulate the domestic economy several times or a certain period of time, while avoiding protectionism, because, after the number of transactions or the amount of time has passed, the Value Claims can be cashed and the purchasing power in the national currency can be spent in other regions and markets. The transaction tax supplies a tool that ensures a contribution of every company that profits from this additional purchasing power of that governmental stimulation program, next of course to the extra economic activities results in additional tax income. An important result of this innovative tool is that it can influence the multiplier of the purchasing power that is introduced in a region, up to the point where the balance between stimulating the regional economy by more economic activities gets less optimal than stimulating that economy by contacting the world market.

The C3 also can charge a small percentage of tax over time (say: 1%/month) over the positive balances in the system. Through this taxation, holding Value Claims will have a cost for the user. This ‘liquidity tax’ can accelerate the velocity of circulation of money (v). Such a liquidity tax might be used within the context of the C3 to stimulate the amount of economic activity in a certain region.

In examples described herein, including the ranking according to time, can be used by big buyers like governments and big companies that want to strengthen their suppliers by making the payments of purchasing power they owe them more immediately available. The disclosure also contains the option that these big buyers produce a list of regular suppliers, allowing these to send their invoice through the C3 as soon as products or services has been delivered to be transferred into a claim to be paid and guaranteed by the big buyer. Specifically, contractors such as governmental institutions and big enterprises with many suppliers can make use of specific options within the C3 model, as described herein.

In the examples below that show this specific disclosure and use of the time ranking (D-rate), governments and/or businesses with many suppliers (the contractors) sign a contract with the C3 in order to provide a white-list of their trusted suppliers. These contractors can consent to guarantee through common agreement with the C3 to the repayment of the claims that are being created as a credit backed by the invoices of these suppliers have to the contractors to the C3 within a defined quantity of days in case the invoice proves to be correct. In addition, the contractors agree to guarantee the repayment of a credit to these suppliers, based on their invoices in case the invoice is rejected by these contractors and the supplier does not repay the credit. The contractors define the maximum amount for each of the listed suppliers, up till what payment and eventually guarantee is being agreed to.

Based on this agreement the C3 administration allows a credit in internal liquidity of the same amount as the invoice to these white-listed suppliers as long as they do not surpass their limit or are removed from the white-list. This liquidity will be immediately available and usable in the C3 circuit. In this process the supplier-company hands over the rights to cash the invoice from the contractor to the C3 to compensate for the credit and additionally agrees that might the invoice be rejected or not paid by the contractor, the supplier will pay back the credit within one month, while recuperating the full rights to claim the invoice at the contractor.

The liquidity, called Value Claims, the supplier acquires in the C3 can be:
used for any payment or settling of debts with other users of the C3—with the additional option to introduce one's own suppliers into the circuit. In this way the supplier uses the advantages of the C3, such as the security and the option to transfer the Value Claims by mobile phone, cards and internet;
converted to national currency at least against the costs of the interest that the C3 will charge and which will depend on the quantity of days the invoice has not yet expired as well as possibly an additional fee for administrative costs; and/or
maintained on the account until the purchasing power is needed or until the invoice has expired and the cost to convert the internal purchasing power into national currency do no longer include the costs to pre-finance the payment of the invoice.

When the contractor agrees with the invoice and has paid the invoice in full to the C3, the credit/payment obligation of the supplier will cease to exist.

In case the invoice is not accepted (and paid) by the government (or other type of contractor) for any reason, the invoice is returned to the supplier with notification of the C3. This should happen at least a certain quantity of days before the moment of invoice was due to be paid. In that case the C3 will request the supplier to repay the credit including the costs the C3 has had to make, before the date the original invoice was supposed to be paid by the contractor. Within the guarantee-agreement the contractor and the C3 has signed, it is arranged that if the supplier fails to make the repayment of the loan in circumstances as described herein, the contract with the contractor will allow the C3 to claim the amount at the contractor as well.

If the supplier seems to have misused the trust, he/she will be removed from the white list and will not be allowed to use the facility anymore.

In the case that the contractor agrees with the invoice but has not paid within the agreed period, C3 is allowed to demand the repayment of the credit by the supplier in exchange of the invoice, which then returns to the supplier.

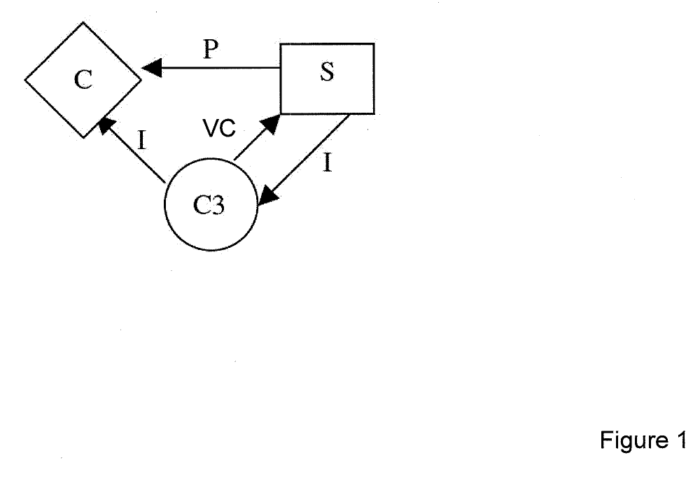

In FIG. 1, the Supplier delivers a Product to the Contractor and sends the Invoice to the C3-administration. In return, the Supplier gets his Invoice paid in C3 Value Claims. The C3 sends the Invoice to the Contractor who will pay an agreed period of time later on.

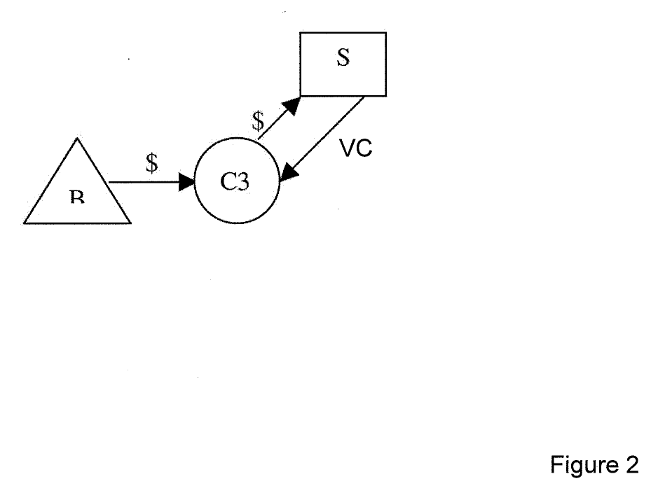

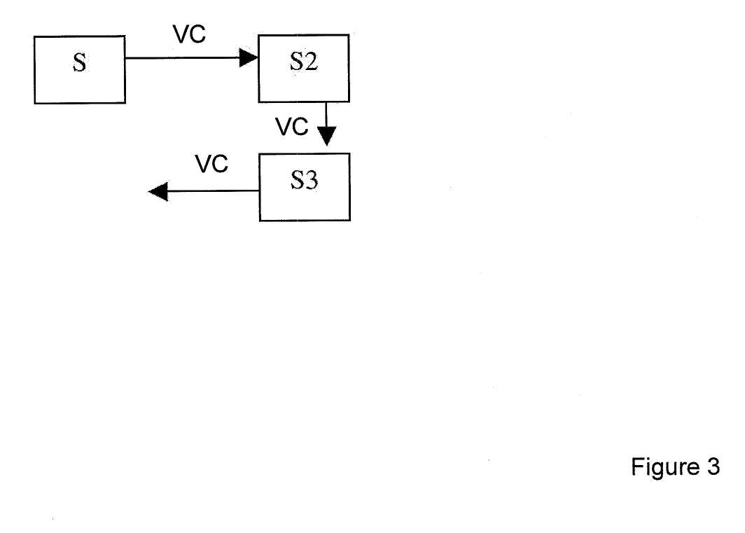

In FIG. 2, the Supplier can exchange its Value Claims for cash ($). However he has to pay the costs the C3 has to pay to borrow the $ at a Bank plus an additional fee to stimulate him to act like the suppliers in FIG. 3.

In FIG. 3, the Supplier spends its Value Claims at his Supplier (S2) who can spend it at his Supplier (S3), etc. Any supplier can exchange its claims for cash. The costs to do so decrease in time because the C3 has to borrow the money for a shorter period of time.

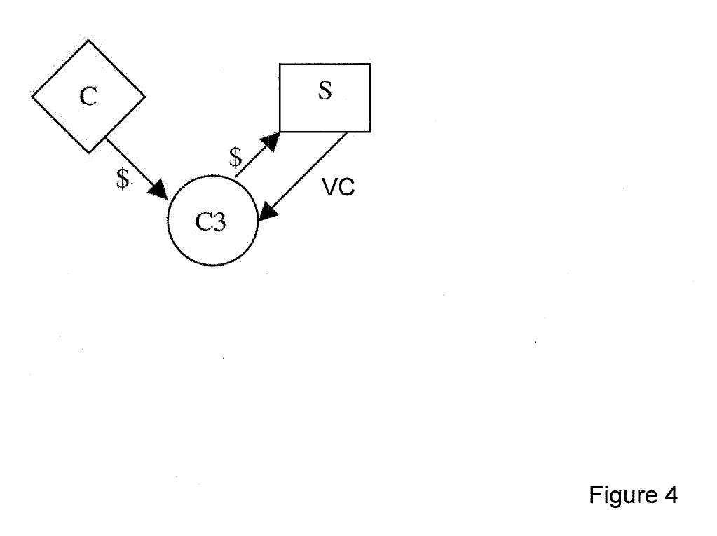

In FIG. 4, once the original invoices have been paid by the Contractor, any member that at that moment holds that purchasing power in the C3 can exchange its Value Claims for cash with only minor costs.

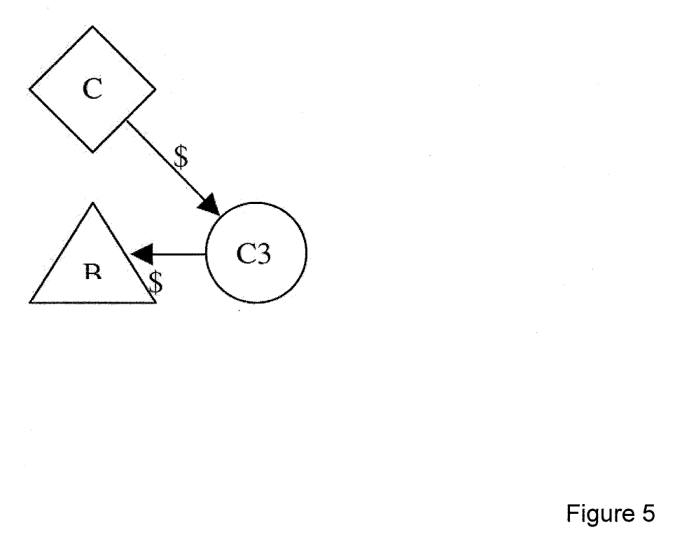

In FIG. 5 can be seen that, in the case of the situation described in FIG. 2, once the Contractor has paid the invoice to the C3, the C3 can pay back the loan to the Bank.

In example embodiments, one or more of the processes of the above methods are implemented using one or more a computing devices.

This system allows suppliers to obtain immediate use of the purchasing power resulting from their sales while at the same time it allows the government or big buyers a reasonable time to pay the delivered products or services.

In another example, the system can be used to decrease or eliminate the lag between payment by a purchaser (“client”) using a credit card and the supplier (“shopkeeper”) receiving value for the purchase that the shopkeeper can use to make immediate purchases.

For example, when a customer pays a shopkeeper by credit card, this payment is guaranteed but also has costs. Also, the shopkeeper has to wait a period of time (typically at least a month) to get the actual payment on the shopkeeper's account by the credit card company.

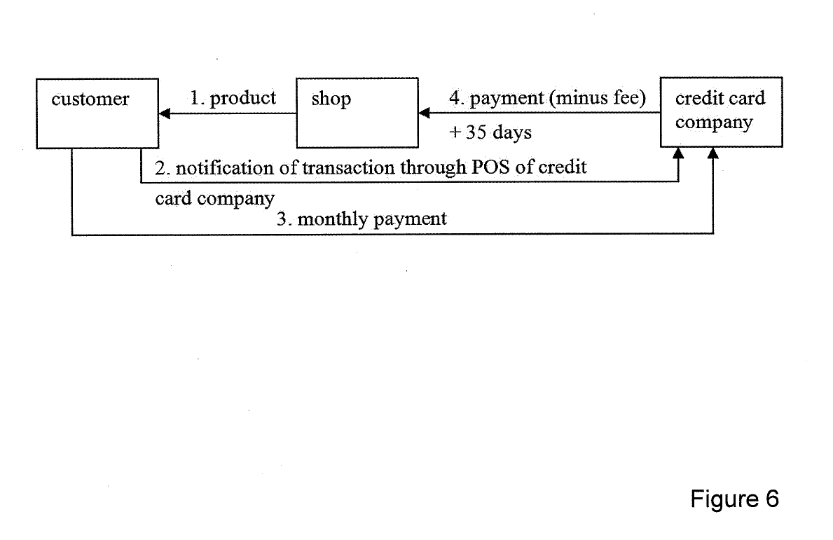

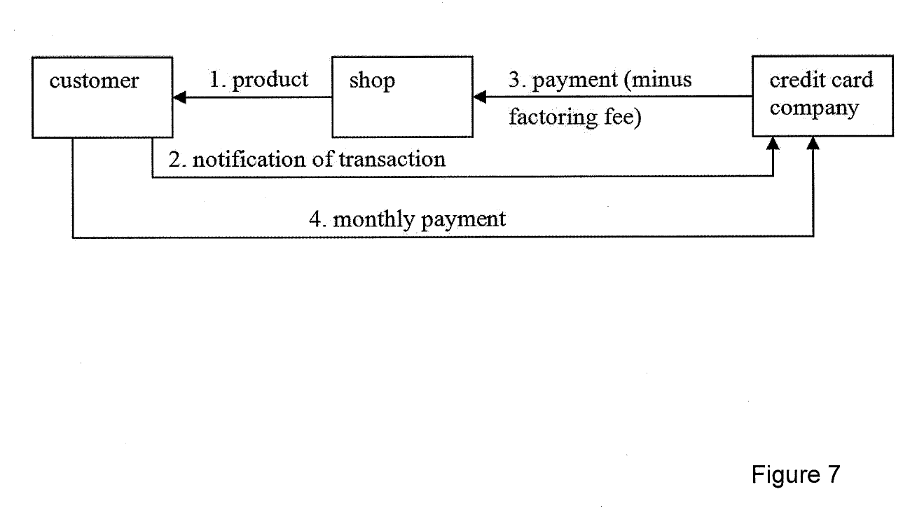

In a typical credit card payment:
the client buys a product (step 1, see FIG. 6) and passes his credit card through a POS machine (step 2).
the credit card company debits immediately or after an established period of time an amount from the client (step 3) and pays this at some specific future moment to the shopkeeper (step 4).
The credit card company can or cannot charge fees from both or either client and shopkeeper.
In most cases the credit card company will receive money from the client at the prefixed date of his monthly installments, and pays money to the shopkeeper normally on date of purchase +35 days.
The credit card will pay money to the shopkeeper no matter whether it has received money from the customer; in other words, the credit card takes the credit risk.
If the shopkeeper needs money before the established date, most credit-card labels offer a form of ‘factoring’ whereby the shopkeeper can get his money in advance against paying an extra fee (see FIG. 7). Some credit cards have bought or founded banks specifically for this, and in Brazil, cards like GoodCard make a very considerable amount of their profits out of these financial transactions.

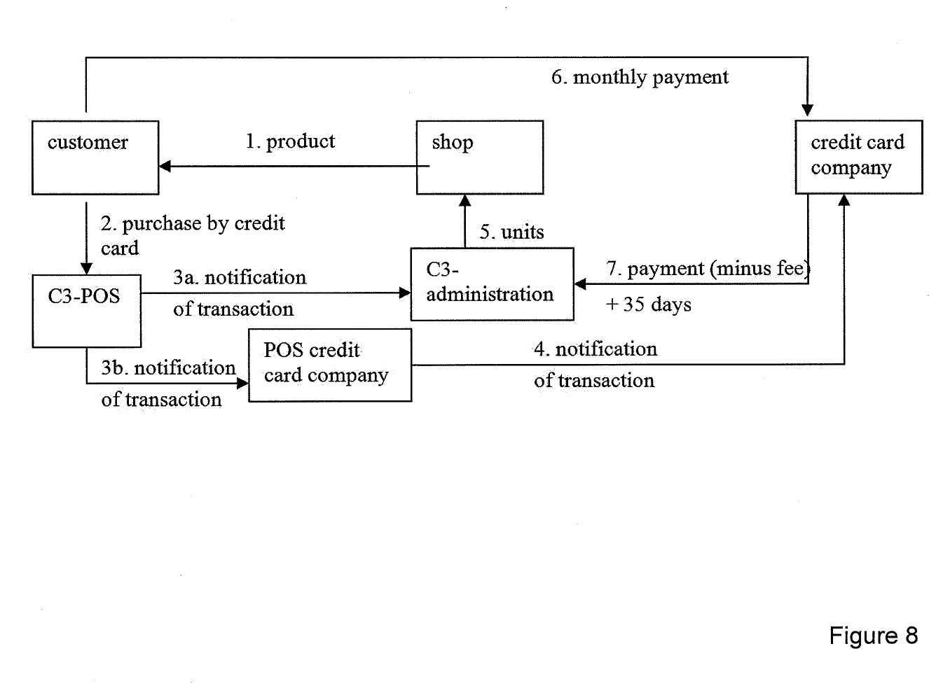

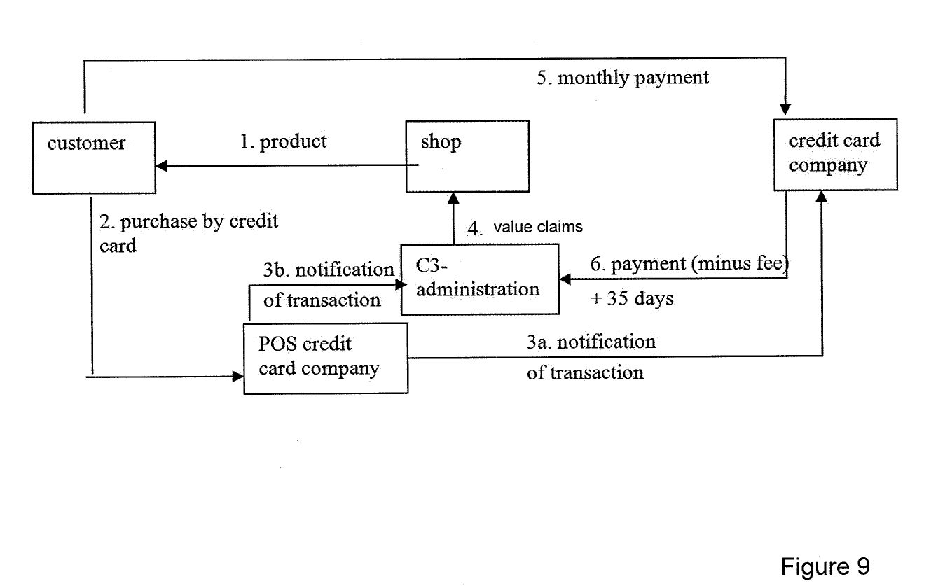

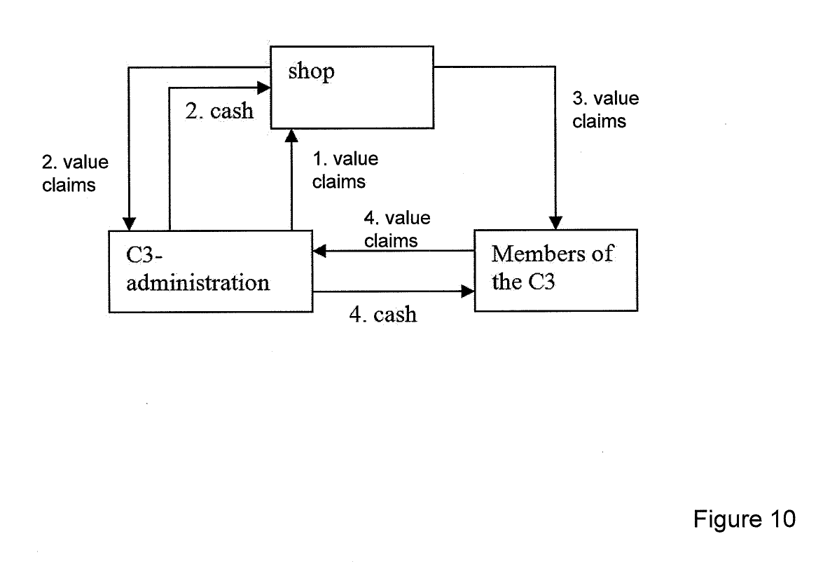

The innovations target to pass the payment through a C3. See FIG. 8.
The shopkeeper now transfers the right of payment (which means the payment on day 35 after the transaction) to the C3 and gets immediately internal purchasing power for it.
This purchasing power is to be used within the C3, or to be exchanged for cash.
The costs for this exchange are highest when this amount is freshly received from the C3 and lowest when the day of payment from the credit card company has passed.
To keep track on this the C3 uses the D-ranking.
Technically, this swap of the right on the cash payment by the credit card company is realized either by juridical means (C3 is the owner of the bill on which the credit card company by contract is obliged to pay), or technically (the actual payment is done through an additional card reader, which is owned by the C3 and which is connected to the credit card company, see FIG. 8). The contract is then between the credit card company and C3).
When a customer makes a purchase (step 1, see FIG. 9), the shopkeeper decides if he is willing to wait for his money, or if he wants immediate liquidity in the form of Value Claims.
If he is willing to wait, he enters the payment process mentioned above in FIG. 6.
If he wants immediate liquidity, he asks the client to pay through the POS of the C3 (step 2) he has signed a contract in which the right on the payment has been transferred to the C3. (The customer does not actively participate in the C3 and does not need to have any established relation with the C3.)
The customer receives a normal debit on his credit card, while the C3 receives the payment from the credit card company (step 6).
The administration of C3 is able (through internal processes that must be developed) to deduct from the information the credit card company gives them, how much money they will receive, in which period, and related to which POS.
With this information, the C3 software generates the liquidity from the debit-account and deposits these Value Claims on the account of the shopkeeper. Automatically the rates are defined and taxes are charged (see FIG. 10).
The shopkeeper can now spend the Value Claims in the C3 or cash these by paying the fees that the C3 charges.

In case customers bring back the goods or the payment is annulled for whatever reason, the shopkeeper takes in the good and pays back from his own cash the purchasing power he received for the transaction.

In this example, the guarantee the credit card companies offer is transferred in immediate purchasing power for the shop owner as if it were cash. This idea that the purchasing power within the C3 is as valuable as money is based on the security C3 introduced (all units are backed by strong guarantees) and on the diminishing malus, which guarantees that in a distinct point in the future one can exchange the units for cash with very minimal costs.

Additional details of the C3 described herein can be found in U.S. Patent Application Ser. No. 61/358,571 filed on Jun. 25, 2010, the entirety of which is hereby incorporated by reference.

Various embodiments described herein can be implemented (1) as a sequence of computer implemented acts or program modules running on a computing system and/or (2) as interconnected machine logic circuits or circuit modules within the computing system. The implementation is a matter of choice dependent on the performance requirements of the computing system. Accordingly, logical operations including related algorithms can be referred to variously as operations, structural devices, acts or modules. It will be recognized by one skilled in the art that these operations, structural devices, acts and modules may be implemented in software, firmware, special purpose digital logic, and any combination thereof without deviating from the spirit and scope of the present disclosure.

While the descriptions according to the present disclosure provide embodiments according to the management system, it is not all inclusive and is recognized that any one skilled in the art to which this pertains may introduce modifications or variations based on the present disclosure. Such modifications or variations as are obvious to one skilled in this art are included in the teaching of the present disclosure.

What is claimed is:

1. A system for introducing liquidity in a market place, comprising:
a provision of value to an entity against a promise of cash at a defined moment in the future
wherein this future payment is secured by an institution, which leads to a standardized value claim that becomes available in a digital network to be used for the entity, and wherein this value claim is redeemable for cash at the defined moment; and
wherein debts are settled by transferring the claims within this system for commercial purposes,
wherein the utilization minimizes use of cash for users of the network and provides an alternate form of payment while forming a standardized payment mechanism substantially compatible with cash.

2. The system of claim 1, wherein participants in the system are part of an established network.

3. The system of claim 1, wherein securitization may be provided by a non-interested third party.

4. The system of claim 1, wherein the securitization is provided by a group selected from banks, insurance companies, brokerage houses, investors or combination thereof.

5. The system of claim 1, wherein an invoice is a base of the value claim.

6. The system of claim 1, wherein the invoice is already paid and cash of that payment is secured as the base of the value claim.

7. The system of claim 6, wherein procurement of a standardized value claim is rewarded with a bonus.

8. The system of claim 1, wherein redemption is executed by a supplier for cash or goods and services.

9. The system of claim 1, wherein claims are generated by commitments to deposit funds at a future time.

10. The system of claim 9, wherein claims on the payments of money at a defined future date are guaranteed.

11. The system of claim 1, wherein holders of standardized value claims pay an exchange fee or malus when they want to collect cash.

12. The system of claim 1, wherein owners of a positive account of standardized value claims can allow others to use an account for his or her benefit.

13. The system of claim 1, wherein parties of the system are in different countries or jurisdictions.

14. The system of claim 1, wherein a bonus is calculated for incentives by ranking.

15. The system of claim 1, wherein fees and bonuses are paid as part of the issuance and redemption of the claims.

16. The system of claim 1, wherein the quantity of days before the defined future date the claim will lead to the cash payment is used to calculate a conversion fee for the consumer.

17. The system of claim 1, wherein a conversion fee is established via relationship that is selected from a group consisting of costs, ranking, transactions, age of claims, or combination thereof.

18. A method of payment based on future claims on money, comprising:
depositing a claim on cash by a first user; creating a standardized value claim based on funds deposited, wherein a depository is a financial institution;
providing the standardized value claim to a second user, wherein the second user utilizes the value claim for subsequent purchase within the claim management system, and wherein the use of the value claims extends an availability of funds in a market place without actual cash.

19. The system of claim 18, wherein the funds are secured by a third party.

20. An accounting system that uses standardized claims that are related to monetary values, comprising:
a plurality of claims, the claims being based on a payment promise at a fixed moment in time;
a security established by an institution that secures that payment promise;
wherein the claims are purchasable for national currency, such a purchase being stimulated by a bonus; and
wherein the claims can be cashed for national currency, upon:
payment of a conversion fee that is zero at the date the payment promise expires; and
when cashing is requested before the promised payment has been paid, the conversion fee will be extended by the costs of borrowing cash for a period until the promise is scheduled is added;
wherein the system calculates, for each user of the system, for how long the claims on each user's account are in circulation, still have to circulate before the promised date of payment, and the number of times the claims on each user's account have been used, these calculations being used to influence:
the otherwise fixed conversion fee so that this can be related to a number of days it will take until a day on which future payment is promised to be done; and
the otherwise fixed conversion fee so that this fee can be related to the number of times the claims have been circulating within the system compared to the targeted number of times.
